(19) United States
(12) Patent Application Publication
(10) Pub. No.: US 2019/0154361 A1
(43) Pub. Date: May 23, 2019

(54) HEAT EXCHANGE DEVICE

(71) Applicant: TOYOTA JIDOSHA KABUSHIKI KAISHA, Toyota-shi (JP)

(72) Inventors: Hirotaka SUNADA, Nagoya-shi (JP); Yoshikazu ABE, Toyota-shi (JP); Taku TAKAGI, Toyota-shi (JP)

(73) Assignee: TOYOTA JIDOSHA KABUSHIKI KAISHA, Toyota-shi (JP)

(21) Appl. No.: 16/144,382

(22) Filed: Sep. 27, 2018

(30) Foreign Application Priority Data
Nov. 21, 2017 (JP) 2017-223910

(51) Int. Cl. F28F 1/40; F28D 7/10; F02F 1/30; F01N 13/08

(52) U.S. Cl. CPC F28F 1/40; F28D 7/10; F28F 2215/00; F01N 13/08; F02F 1/30

(57) ABSTRACT

A heat exchange device includes: a first flow path through which a first fluid flows; a second flow path through which a second fluid flows, the second flow path being separated from the first flow path by a tubular partition wall and positioned close to an outer circumference of the tubular partition wall; an offset fin installed in a tubular shape extending along an inner circumferential surface of the tubular partition wall; and a pressing member disposed inward of the offset fin such that the offset fin is pressed toward the inner circumferential surface of the partition wall while being elastically deformed. The offset fin is provided with a plurality of wave-shaped portions arranged in an axial direction of the tubular partition wall and positions of wave-shapes of the wave-shaped portions adjacent to each other are offset from each other in a circumferential direction of the tubular partition wall.

### INCORPORATION BY REFERENCE

The disclosure of Japanese Patent Application No. 2017-223910 filed on Nov. 21, 2017 including the specification, drawings and abstract is incorporated herein by reference in its entirety.

### BACKGROUND

### 1. Technical Field

The present disclosure relates to a heat exchange device.

### 2. Description of Related Art

A heat exchange device that is used to cool a fluid for an internal combustion engine of an automobile or the like is known. The heat exchange device includes a first flow path and a second flow path through which a first fluid and a second fluid respectively flow and heat is exchanged between the first fluid and the second fluid. For example, in Japanese Unexamined Patent Application Publication (Translation of PCT Application) No. 2010-503817 (JP 2010-503817 A), a tubular partition wall that separates the first flow path and the second flow path such that the first flow path and the second flow path are positioned inward and outward of the partition wall, respectively. Fins that protrude inward from an inner circumferential surface of the partition wall are integrally formed with the partition wall. With the fins as described above, it is possible to secure a heating surface area between the first fluid and the second fluid such that there is an improvement in heat exchange efficiency.

### SUMMARY

It is desired to further improve the heat exchange efficiency of a heat exchange device as described above.

The present disclosure provides a heat exchange device with improved heat exchange efficiency.

An aspect of the present disclosure relates to a heat exchange device including a first flow path, a second flow path, an offset fin, and a pressing member. The first flow path is configured such that a first fluid flows through the first flow path. The second flow path is configured such that a second fluid flows through the second flow path, the second flow path is separated from the first flow path by a tubular partition wall, and the second flow path is positioned close to an outer circumference of the tubular partition wall. The offset fin is installed in a tubular shape extending along an inner circumferential surface of the tubular partition wall. The pressing member is disposed inward of the offset fin such that the offset fin is pressed toward the inner circumferential surface of the partition wall while being elastically deformed. The offset fin is provided with a plurality of wave-shaped portions arranged in an axial direction of the tubular partition wall, and the wave-shaped portions are provided such that the positions of wave-shapes of the wave-shaped portions adjacent to each other offset from each other in a circumferential direction of the tubular partition wall. Since the offset fin is adopted, it is possible to secure a heating surface area between the first fluid and the second fluid. In addition, since the pressing member presses the offset fin toward the inner circumferential surface of the partition wall with the offset fin elastically deformed, the offset fin comes into close contact with the inner circumferential surface. Accordingly, heat is efficiently transmitted between the first fluid and the second fluid and there is an improvement in heat exchange efficiency.

In the heat exchange device according to the aspect of the present disclosure, the pressing member may be a solid shaft.

In the heat exchange device according to the aspect of the present disclosure, the pressing member may be provided with a guiding portion configured to guide the first fluid toward the offset fin side.

In the heat exchange device according to the aspect of the present disclosure, the pressing member may be provided with a tubular portion configured to press the offset fin toward the inner circumferential surface side and an opening portion provided in a circumferential wall of the tubular portion and the guiding portion may guide the first fluid toward the offset fin side from an area in the tubular portion through the opening portion.

In the heat exchange device according to the aspect of the present disclosure, the guiding portion may spirally extend in an axial direction of the first flow path.

In the heat exchange device according to the aspect of the present disclosure, the pressing member may be provided with a blocking portion configured to block a space surrounded by the offset fin, the blocking portion being provided in an end portion of the pressing member that is on a downstream side in the first flow path.

According to the aspect of the present disclosure, it is possible to provide a heat exchange device with improved heat exchange efficiency.

### BRIEF DESCRIPTION OF THE DRAWINGS

Features, advantages, and technical and industrial significance of exemplary embodiments of the present disclosure will be described below with reference to the accompanying drawings, in which like numerals denote like elements, and wherein:

FIG. 1A is a sectional view of a heat exchange device as seen in a direction orthogonal to an exhaust gas flow path and a coolant flow path;

FIG. 1B is a sectional view of the heat exchange device as seen in a direction parallel to the exhaust gas flow path and the coolant flow path;

FIG. 2A is an enlarged view of a portion of an offset fin in a state before the offset fin is elastically deformed into a cylindrical shape;

FIG. 2B is a perspective view of a portion of the offset fin in a state after the offset fin is elastically deformed into a cylindrical shape;

FIG. 2C is an enlarged view of a portion of the offset fin installed between a partition wall and a pressing member;

FIG. 3A is an explanatory view of a heat exchange device in a modification example;

FIG. 3B is an explanatory view of the heat exchange device in the modification example;

FIG. 4 illustrates a substrate in a state before the pressing member is processed into a cylindrical shape;

FIG. 5A is an explanatory view of a heat exchange device in a modification example; and

FIG. 5B is an explanatory view of the heat exchange device in the modification example.

### DETAILED DESCRIPTION OF EMBODIMENTS

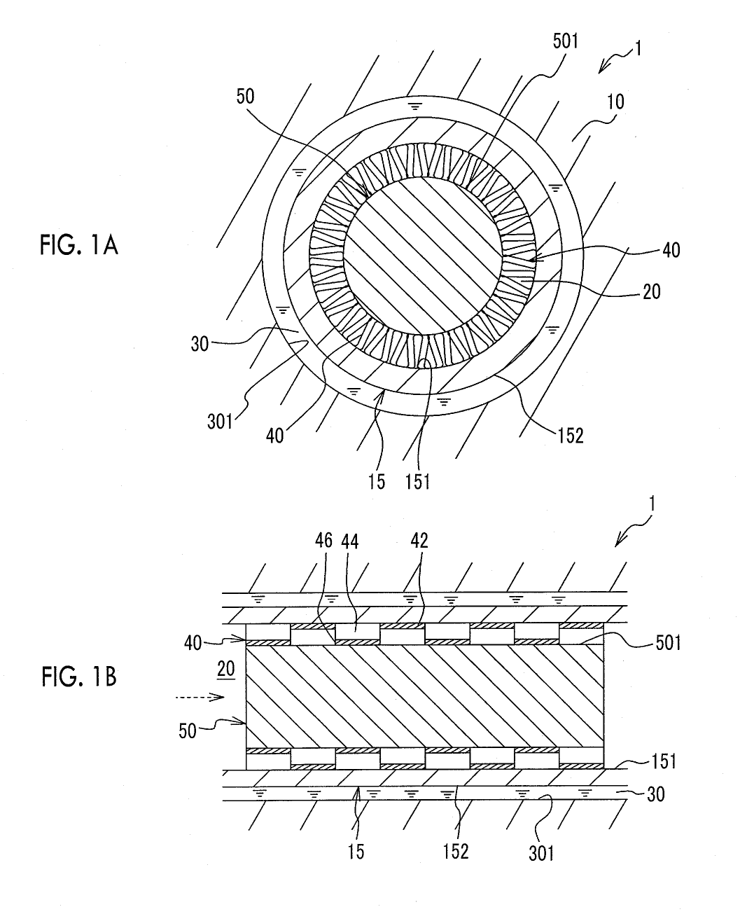

FIG. 1A is a sectional view of a heat exchange device 1 as seen in a direction orthogonal to an exhaust gas flow path 20 and a coolant flow path 30. FIG. 1B is a sectional view of the heat exchange device 1 as seen in a direction parallel to the exhaust gas flow path 20 and the coolant flow path 30. The heat exchange device 1 is integrally provided in a cylinder head 10 of an engine. Specifically, in the cylinder head 10, the heat exchange device 1 is integrally provided with an exhaust gas recirculation (EGR) path for returning a portion of exhaust gas from the engine to an intake side and the heat exchange device 1 is provided in the EGR path.

An exhaust gas and a coolant flow through the exhaust gas flow path 20 and the coolant flow path 30, respectively. The exhaust gas flow path 20 constitutes a portion of the EGR path. The coolant cools the engine and the temperature of the coolant is lower than that of the exhaust gas. The exhaust gas flow path 20 and the coolant flow path 30 are separated from each other by a partition wall 15. The coolant flow path 30 is formed to be disposed outward of the partition wall 15 and the exhaust gas flow path 20 is formed to be disposed inward of the partition wall 15. The partition wall 15 is formed in an approximately cylindrical shape and is provided with an inner circumferential surface 151 and an outer circumferential surface 152. The coolant flow path 30 is provided with an inner circumferential surface 301 having a cylindrical shape. The outer circumferential surface 152 of the partition wall 15 faces the inner circumferential surface 301 of the coolant flow path 30. The exhaust gas and the coolant are examples of a first fluid and a second fluid, respectively. The exhaust gas flow path 20 and the coolant flow path 30 are examples of a first flow path and a second flow path through which the exhaust gas and the coolant flow, respectively. The inner circumferential surface 151 of the partition wall 15 is an example of an inner circumferential surface of the first flow path.

In the exhaust gas flow path 20, an offset fin 40 and a pressing member 50 are disposed. The offset fin 40 is installed in the exhaust gas flow path 20 in a state of being elastically deformed into a cylindrical shape. The pressing member 50 is press-fitted to be disposed inward of the offset fin 40 having the cylindrical shape. The pressing member 50 is a solid shaft provided with an outer circumferential surface 501 having a cylindrical shape. In other words, the pressing member 50 has a columnar shape. The pressing member 50 is, for example, formed of metal, such as stainless steel. The exhaust gas flows in an area between the inner circumferential surface 151 of the partition wall 15 and the outer circumferential surface 501 of the pressing member 50 and flows in the vicinity of the offset fin 40. When the offset fin 40 is provided in the exhaust gas flow path 20 as described above, a heating surface area between the exhaust gas and the coolant can be secured and there is an improvement in heat exchange efficiency.

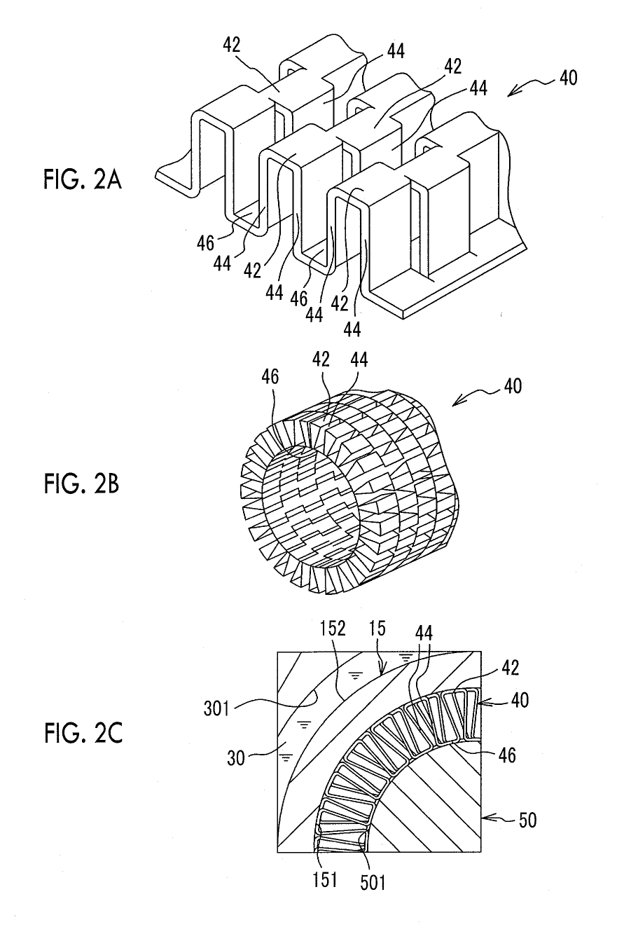

FIG. 2A is an enlarged view of a portion of the offset fin 40 in a state before the offset fin 40 is elastically deformed into the cylindrical shape. The offset fin 40 is manufactured when a plate member that is formed of metal material, such as stainless steel which is resistant to corrosion and is elastically deformable, is subject to slit processing or press working. The offset fin 40 is configured such that wave-shapes, which are formed by an upper wall portion 42, a side wall portion 44, a bottom wall portion 46, and the side wall portion 44 being alternately and repeatedly disposed, are arranged in a direction orthogonal to a direction in which each wave extends. The lengths of the upper wall portion 42 and the bottom wall portion 46 in the direction in which each wave extends are the same as each other. The upper wall portion 42 and the bottom wall portion 46 are approximately parallel to each other. The side wall portion 44 is curved to be approximately perpendicular to the upper wall portion 42 and the bottom wall portion 46. Adjacent wave-shapes are offset from each other by half the length of the upper wall portion 42 and the bottom wall portion 46 in the direction in which each wave extends. In a state before the offset fin 40 is elastically deformed, the wave-shapes are arranged on a plane. The thickness of the entire offset fin 40 which corresponds to a distance between the upper wall portion 42 and the bottom wall portion 46 in a direction perpendicular to the upper wall portion 42 and the bottom wall portion 46 is uniform regardless of the position in a plane direction.

FIG. 2B is a perspective view illustrating a portion of the offset fin 40 after the offset fin 40 is elastically deformed into the cylindrical shape. FIG. 2C is an enlarged view of a portion of the offset fin 40 installed between the partition wall 15 and the pressing member 50. Here, the pressing member 50 presses the offset fin 40 toward the inner circumferential surface 151 of the partition wall 15. Specifically, the pressing member 50 is configured as follows.

In a case where the partition wall 15 and the pressing member 50 are coaxially disposed, a distance between the inner circumferential surface 151 of the partition wall 15 and the outer circumferential surface 501 of the pressing member 50 in a radial direction is set to be smaller than the thickness of the entire offset fin 40 before the elastic deformation. Therefore, as illustrated in FIGS. 2A and 2C, the side wall portion 44 is elastically deformed such that the side wall portion 44 is slightly inclined and thus an angle between the side wall portion 44 and the upper wall portion 42 and an angle between the side wall portion 44 and the bottom wall portion 46 are changed from those before the elastic deformation since the offset fin 40 is installed between the inner circumferential surface 151 and the outer circumferential surface 501. It is a matter of course that the circumference of the inner circumferential surface 151 of the partition wall 15 is larger than the circumference of the outer circumferential surface 501 of the pressing member 50. Therefore, the side wall portion 44 is elastically deformed such that an interval between upper wall portions 42 that are adjacent with each other in a circumferential direction is wider than an interval between bottom wall portions 46 that are adjacent with each other in the circumferential direction and thus the influence of the difference between the circumferences is suppressed. The offset fin 40 is elastically deformed in this manner and the upper wall portion 42 and the bottom wall portion 46 come into close contact with the inner circumferential surface 151 of the partition wall 15 and the outer circumferential surface 501 of the pressing member 50, respectively. The exhaust gas flows between side wall portions 44 that are adjacent with each other in the circumferential direction.

As described above, the pressing member 50 presses the offset fin 40 toward the inner circumferential surface 151 of the partition wall 15. Here, there may be a case where the pressing member 50 is not provided. For example, there may be a case where the upper wall portion 42 of the offset fin 40 does not come into close contact with the inner circumferential surface 151. In this case, heat of the exhaust gas that is received by the offset fin 40 may not be efficiently transmitted to the coolant via the partition wall 15 and there may be a decrease in heat exchange efficiency.

In the present embodiment, the pressing member 50 presses the offset fin 40 toward the inner circumferential surface 151 of the partition wall 15 and thus the upper wall portion 42 of the offset fin 40 comes into close contact with the inner circumferential surface 151. Therefore, heat is efficiently transmitted between the exhaust gas and the coolant via the offset fin 40 and the partition wall 15 and thus there is an improvement in heat exchange efficiency.

Since the pressing member 50 presses the offset fin 40 toward the inner circumferential surface 151 of the partition wall 15, wobbling of the offset fin 40 in the exhaust gas flow path 20 is suppressed. Therefore, wobbling of the offset fin 40 which is caused by vibration of the engine and an increase in noise which is caused by the wobbling are suppressed. Since positional deviation of the offset fin 40 in an axial direction is also suppressed, the offset fin 40 can be continuously held at a desired position at which an excellent heat exchange efficiency can be achieved.

Both of the outer circumferential surface 501 of the pressing member 50 and the inner circumferential surface 151 of the partition wall 15 have a cylindrical shape and the thickness of the offset fin 40 is uniform. Therefore, the offset fin 40 elastically deformed into a cylindrical shape can uniformly come into close contact with the inner circumferential surface 151 regardless of the position in the circumferential direction, and thus there is an improvement in heat exchange efficiency.

Since the pressing member 50 is a solid shaft, the strength of the pressing member 50 is secured. Accordingly, for example, when manufacturing the heat exchange device 1, it is possible to press-fit the pressing member 50 such that the pressing member 50 is disposed inward of the offset fin 40 that is disposed in a cylindrical shape extending along the partition wall 15, without consideration of deformation of the pressing member 50. Therefore, it is possible to manufacture the heat exchange device 1 in a short time and thus it is possible to suppress an increase in manufacturing cost.

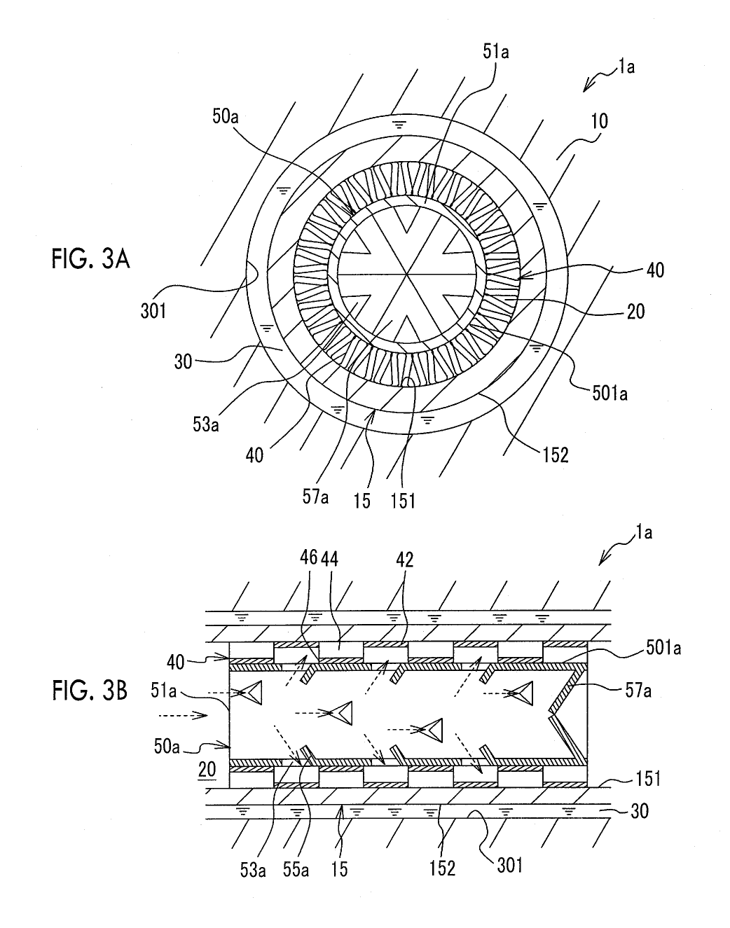

A heat exchange device in a modification example will be described. Note that, the same configurations as in the embodiment will be given the same reference numerals and repetitive description thereof will be omitted. FIGS. 3A and 3B are explanatory views of a heat exchange device 1a in the modification example. FIGS. 3A and 3B respectively correspond to FIGS. 1A and 1B. A pressing member 50a is provided with a tubular portion 51a and a blocking portion 57a provided in a downstream side end of the tubular portion 51a. An outer circumferential surface 501a of the tubular portion 51a comes into contact with the bottom wall portions 46 of the offset fin 40 and the offset fin 40 is pressed toward the inner circumferential surface 151 of the partition wall 15. Therefore, there is an improvement in heat exchange efficiency also in the heat exchange device 1a.

A plurality of opening portions 53a is formed in a circumferential wall of the tubular portion 51a such that the opening portions 53a are disposed at different positions in the circumferential direction and the axial direction of the tubular portion 51a. The opening portions 53a are formed to have isosceles triangular shapes. Guiding portions 55a are erected toward an area in the tubular portion 51a at positions downstream of the opening portions 53a. The guiding portions 55a block the opening portions 53a before being erected and the guiding portions 55a and have isosceles triangular shapes as with the opening portions 53a. The guiding portions 55a are erected toward the area in the tubular portion 51a at an angle of less than 90 degrees. Therefore, the exhaust gas intruding into the tubular portion 51a is guided toward the offset fin 40 side by the guiding portions 55a through the opening portions 53a.

The downstream side end of the tubular portion 51a is provided with the blocking portion 57a and the blocking portion 57a blocks a space surrounded by the tubular portion 51a. Therefore, the exhaust gas intruding into the tubular portion 51a is restrained from passing through the tubular portion 51a without flowing in the vicinity of the offset fin 40. Accordingly, the exhaust gas intruding into the tubular portion 51a is guided toward the offset fin 40 side and thus there is an improvement in heat exchange efficiency.

As described above, the opening portions 53a and the guiding portions 55a are formed to be disposed at different positions in the circumferential direction and the axial direction of the tubular portion 51a. Therefore, the exhaust gas intruding into the tubular portion 51a is restrained from being unevenly guided to a position on the offset fin 40 side. This feature also results in an improvement in heat exchange efficiency. Since the pressing member 50a is not solid, the weight of the pressing member 50a is light in comparison with a case where the pressing member 50a is solid. An increase in amount of heat accumulated in the pressing member 50a which is caused by the exhaust gas is also suppressed and the exhaust gas can be efficiently cooled.

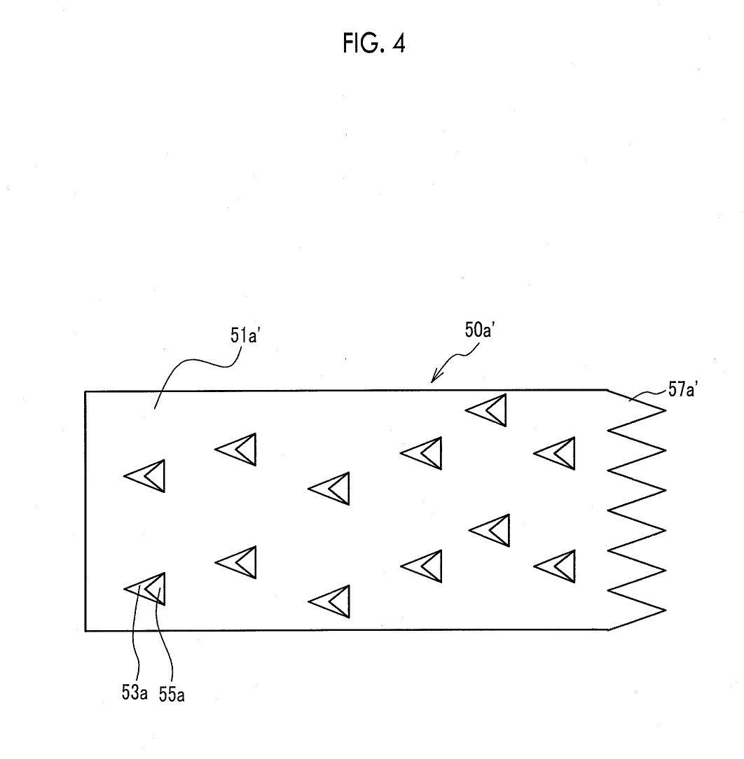

FIG. 4 illustrates a substrate 50a′ in a state before the pressing member 50a is processed into a cylindrical shape. The substrate 50a′ is formed by shearing stainless steel and is formed with an approximately rectangular flat plate portion 51a′ and a serrated portion 57a′ at which consecutive isosceles triangular shapes are arranged along one side of the flat plate portion 51a′.

A plurality of slits is formed in the flat plate portion 51a′ through slit processing, the slits having a V-shape when seen in such a manner that the upstream side in a direction in which the exhaust gas flows is on the lower side. Portions surrounded by the slits are erected toward the same side with respect to the flat plate portion 51a′ such that the opening portions 53a and the guiding portions 55a are formed at the same time. Since it is possible to form the opening portions 53a and the guiding portions 55a at the same time with a simple process as described above, an increase in the number of components or an increase in manufacturing cost is suppressed.

The serrated portion 57a′ is erected toward the same side as the guiding portions 55a and the flat plate portion 51a′ is plastically deformed into a cylindrical shape such that tip ends of the serrated portion 57a′ come into contact with each other. In this manner, the pressing member 50a provided with the blocking portion 57a is manufactured. As described above, the blocking portion 57a is also integrally formed with one sheet of stainless steel, an increase in the number of components or an increase in manufacturing cost is suppressed. Note that, although the above-described configuration is preferable, the configuration is not limited to this and the tubular portion 51a formed with the opening portions 53a, the guiding portions 55a, and the blocking portion 57a may be bonded to each other through welding or the like after being separately manufactured.

The shapes of the opening portions 53a and the guiding portions 55a are not limited to those described above and may be square shapes, trapezoidal shapes, semi-circular shapes, or the like. The positions, the sizes, and the numbers of the opening portions 53a and the guiding portions 55a are not limited to those in the above example. Note that, in order to guide the exhaust gas to the offset fin 40 side from the area in the tubular portion 51a through the opening portions 53a, the areas and sizes of the opening portions 53a are preferably designed such that the offset fin 40 cannot be completely blocked by the bottom wall portions 46.

As illustrated in FIG. 3B, the serrated portion 57a′ illustrated in FIG. 4 is erected at an angle of 90 degrees or more such that the tip ends of the serrated portion 57a′ face the upstream side. However, the configuration is not limited to this. For example, the serrated portion 57a′ may be erected at an angle of approximately 90 degrees and the serrated portion 57a′ may be erected to such an extent that the tip ends face the downstream side.

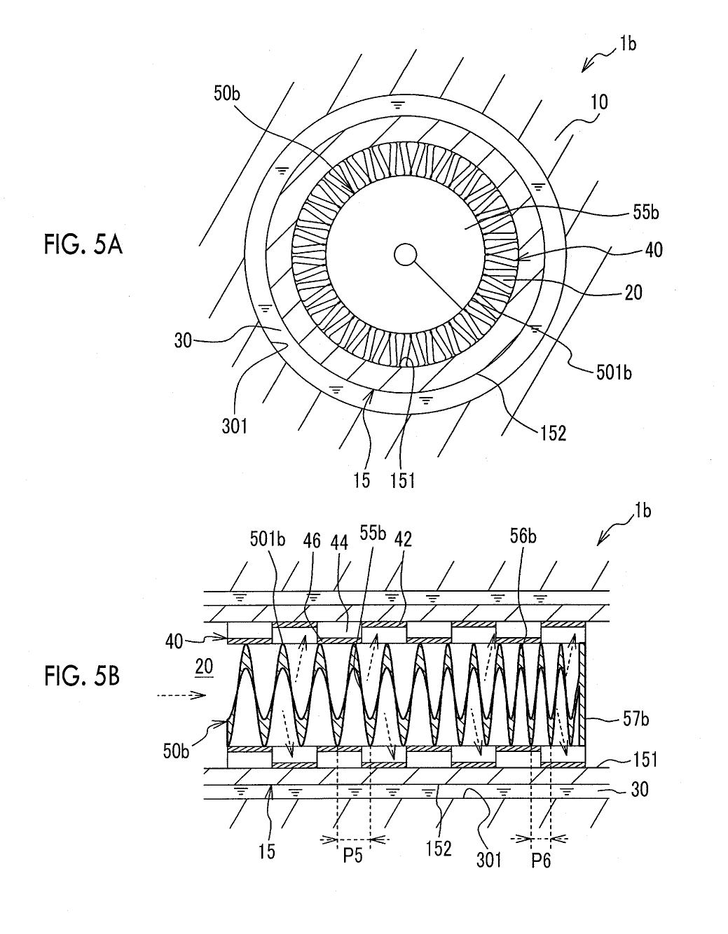

FIGS. 5A and 5B are explanatory views of a heat exchange device 1b in a modification example. FIGS. 5A and 5B respectively correspond to FIGS. 1A and 1B. A pressing member 50b is provided with guiding portions 55b, 56b that spirally extend in the axial direction of the exhaust gas flow path 20. Due to the guiding portions 55b and 56b, the exhaust gas is guided toward the offset fin 40 side while swirling around the pressing member 50b.

Here, the guiding portions 56b are positioned downstream of the guiding portions 55b and an axial pitch interval P6 between the guiding portions 56b is formed to be smaller than an axial pitch interval P5 between the guiding portions 55b. Therefore, the exhaust gas can be sufficiently guided to the offset fin 40 side by the guiding portions 56b on the downstream side. Note that, although the above-described configuration is preferable, the configuration is not limited to this and axial pitch intervals between the spiral-shaped guiding portions may be constant.

The diameters of outer circumferential edges 501b of the guiding portions 55b, 56b are constant, and the outer circumferential edges 501b press the offset fin 40 toward the inner circumferential surface 151 of the partition wall 15. Therefore, there is an improvement in heat exchange efficiency. As with the pressing member 50a, the pressing member 50b is not solid. Therefore, the weight of the pressing member 50b is light and an increase in amount of accumulated heat is suppressed.

A blocking portion 57b is formed in a downstream side end of the guiding portion 56b and is formed in an approximately circular shape. Therefore, a larger amount of exhaust gas can be guided toward the offset fin 40 side and there is an improvement in heat exchange efficiency.

The guiding portions 55b, the guiding portions 56b, and the blocking portion 57b are integrally molded with each other by subjecting a single metal plate to a shearing process and a bending process. Therefore, an increase in the number of components or an increase in manufacturing cost is suppressed in comparison with a case where the guiding portions 55b, the guiding portions 56b, and the blocking portion 57b are separately formed. Note that, although the above-described configuration is preferable, the configuration is not limited to this and the guiding portions 55b, the guiding portions 56b, and the blocking portion 57b may be bonded to each other through welding after being separately manufactured.

The pressing member 50b is not provided with a central shaft. However, the pressing member 50b may be provided with a central shaft and the guiding portions 55b, 56b are provided around the central shaft.

Hereinabove, the embodiment of the present disclosure has been described. However, the embodiment of the present disclosure is not limited to a specific embodiment as described above and various modifications and changes can be made without departing from the gist of the present disclosure described in embodiments above.

In the embodiment and the modification examples, the offset fin 40 comes into direct contact with the inner circumferential surface 151 of the partition wall 15. However, the configuration is not limited to this and a cylindrical member formed of material with excellent thermal conductivity may be interposed between the offset fin 40 and the inner circumferential surface 151.

In the embodiment and the modification examples, the inner circumferential surface 151 of the partition wall 15 has a cylindrical shape. However, the configuration is not limited to this and the inner circumferential surface 151 may have an elliptical cylindrical shape or a rectangular tubular shape. In this case, it is desirable that the outer circumferential surface and an outer circumferential edge of the pressing member also have an elliptical cylindrical shape or a rectangular tubular shape in order to be matched with the shape of the inner circumferential surface 151. This is because the offset fin can come into close contact with the inner circumferential surface 151 of the partition wall 15 with a uniform force at every position in the circumferential direction in this case.

In the modification examples described above, the blocking portions 57a, 57b may not completely block the space surrounded by the offset fin 40 as long as the flow rate of the exhaust gas passing through the space surrounded by the offset fin 40 can be reduced.

In the embodiment and the modification examples, the offset fin 40 extends in the plane direction as illustrated in FIG. 2A before being elastically deformed. However, the configuration is not limited to this and the offset fin 40 may be an offset fin that is formed in a tubular shape in advance. This is because the offset fin can come into close contact with the inner circumferential surface 151 of the partition wall 15 while being elastically deformed by the pressing member such that the diameter of the offset fin is also increased in this case.

In the embodiment and the modification examples, the description has been made by using a case in which the heat exchange device is integrally provided in the engine as an example. However, the configuration is not limited to this and, for example, the heat exchange device may be integrally formed with the exhaust gas path. For example, a double-pipe structure may be adopted such that the first fluid flows in an inner pipe and the second fluid flows between an outer pipe and the inner pipe. The heat exchange device in the embodiment and the modification examples may be applied to, for example, a system other than an engine that uses a thermodynamic cycle. The description has been made by using gas and liquid as examples of the first fluid and the second fluid, respectively. However, the configuration is not limited to this and the first fluid and the second fluid may be liquid and gas respectively and both of the first fluid and the second fluid may be gas or liquid.

What is claimed is:

1. A heat exchange device comprising:
a first flow path configured such that a first fluid flows through the first flow path;
a second flow path configured such that a second fluid flows through the second flow path, the second flow path being separated from the first flow path by a tubular partition wall and the second flow path being positioned close to an outer circumference of the tubular partition wall;
an offset fin installed in a tubular shape extending along an inner circumferential surface of the tubular partition wall, the offset fin being provided with a plurality of wave-shaped portions arranged in an axial direction of the tubular partition wall and the wave-shaped portions being provided such that positions of wave-shapes of the wave-shaped portions adjacent to each other offset from each other in a circumferential direction of the tubular partition wall; and
a pressing member disposed inward of the offset fin such that the offset fin is pressed toward the inner circumferential surface of the partition wall while being elastically deformed.

2. The heat exchange device according to claim 1, wherein the pressing member is a solid shaft.

3. The heat exchange device according to claim 1, wherein the pressing member is provided with a guiding portion configured to guide the first fluid toward the offset fin side.

4. The heat exchange device according to claim 3, wherein:
the pressing member is provided with a tubular portion configured to press the offset fin toward the inner circumferential surface side and an opening portion provided in a circumferential wall of the tubular portion; and
the guiding portion guides the first fluid toward the offset fin side from an area in the tubular portion through the opening portion.

5. The heat exchange device according to claim 3, wherein the guiding portion spirally extends in an axial direction of the first flow path.

6. The heat exchange device according to claim 3, wherein the pressing member is provided with a blocking portion configured to block a space surrounded by the offset fin, the blocking portion being provided in an end portion of the pressing member that is on a downstream side in the first flow path.
